(19) United States
(12) Patent Application Publication
(10) Pub. No.: US 2007/0100727 A1
(43) Pub. Date: May 3, 2007

(54) METHOD AND SYSTEM FOR PROVIDING FLEXIBLE INCOME, LIQUIDITY OPTIONS AND PERMANENT LEGACY BENEFITS FOR ANNUITIES

(76) Inventors: Corey Blaine Multer, Merrick, NY (US); Robert L. Conway, Babylon, NY (US)

Correspondence Address: DREIER LLP, 499 PARK AVE, NEW YORK, NY, 10022, US

(21) Appl. No.: 11/463,779

(22) Filed: Aug. 10, 2006

Related U.S. Application Data
(63) Continuation-in-part of application No. 10/414,690, filed on Apr. 16, 2003.

(51) Int. Cl. G06Q 40/00

(52) U.S. Cl. 705/36 R

(57) ABSTRACT

Methods and systems are described herein for providing an annuity including flexible income, liquidity options or permanent legacy benefits. Providing the annuity generally includes receiving information useful for issuing an annuity that provides for a first level of income payments during a first time period and a second level of income payments during a second time period following the first time period. The second payment level may be contingent on a first event. An annuity premium is computed to provide the first level of income payments and the contingent second level of income payments. The annuity is issued generally upon receipt of a portion of the computed premium.

### CROSS-REFERENCE TO RELATED APPLICATIONS

The present application is a continuation-in-part application of U.S. patent application Ser. No. 10/414,690, filed Apr. 16, 2003, which is herein incorporated by reference in its entirety, and to which, priority is claimed.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

This invention relates generally to retirement planning. Some embodiments of the invention relate to methods and systems for providing annuities with liquidity options and permanent legacy benefits. Other embodiments of the invention relate to methods and systems for providing annuities with flexible payment features.

### BACKGROUND OF THE INVENTION

Individuals generally prepare for retirement by first determining a desired retirement income and then preparing a plan to achieve the desired retirement income, which can be anywhere between 40%-80% of the pre-retirement income, or more, based on the individual's retirement goals and concessions, e.g., travel, new car purchases, etc., for the life of the individual. Financial planning for retirement is generally separated into two time periods: pre- and post-retirement. During the pre-retirement phase, the individual's goal is to accumulate sufficient assets, such as savings, investments, etc., for the given time period to achieve the desired retirement income. The post-retirement goal is to manage the accumulated assets in order to maintain the desired income for the life of the individual, which now may exceed 30 years beyond the individual's retirement date.

The assets accumulated for retirement may include, for example, cash, securities, real and personal property, retirement and employee benefits, and various insurance products, such as annuities. Annuities are generally contracts that provide individuals with means to accumulate money and/or turn accumulated money into future income payments, for a predefined period of time, computed based on the life expectancy of one or more annuitants. The income payments may be guaranteed for the life or lives of the annuitants and/or for a term certain, such as 5, 10, 15, or 20 years. Annuities are typically purchased from insurance companies that offer a variety of options with regard to the manner in which the income payments are disbursed. Immediate annuities, for example, provide income payments that generally begin immediately or within one year of the contract date. Alternatively, deferred annuities, as the name applies, provide income payments beginning at a later date, such as at the date the owner selects as the annuitant's retirement date. The purchaser of an annuity may pay for the annuity over a period of time or in a lump sum. In the latter case the annuity may be referred to as a Single Premium Annuity (SPA) or in the case of immediate annuity a Single Premium Immediate Annuity (SPIA).

Although annuities are often a prudent investment strategy for many individuals due, for instance, to the lifetime payment guarantee and certain tax and spendthrift advantages above alternative investments, the lack of or limited liquidity associated with annuities during the payout phase may result in potential annuitants passing up annuities as an investment option. Currently, once selected at issuance annuity payments, i.e., annuity income, do not change in amount or frequency. In addition, liquidity options appearing in annuities in the art typically include restrictions or limitations that either prevent or dissuade the annuitant from exercising the options to convert the annuity or a portion thereof into cash except in certain predefined and typically extenuating circumstances. For example, certain annuities include liquidity options in the form of accelerated benefits that allow annuitants diagnosed with a critical illness to elect to accelerate income payment in order to receive a lump sum benefit in lieu of future payments. Such accelerated benefits, however, do not provide liquidity for annuitants in other than life threatening circumstances and thus provide no measure of relief for annuitants that may need money for less extenuating circumstances.

Additionally, certain annuities provide liquidity by allowing annuitants to withdraw all or part of an amount of an applicable guaranteed minimum payment duration or total of payments, such as up to the paid premium or a portion thereof. However, since the amount of the withdrawal is generally limited to the value of the predetermined minimum payment duration or total, owners may find there is little remaining value to benefit from a withdrawal at precisely the time when their need for liquidity is more likely to arise.

Annuities further fail to provide adequate legacy benefits to beneficiaries after the annuitants die. An annuity purchaser has a variety of options regarding payments to beneficiaries. For example, periodic income payments to a selected beneficiary may commence after the annuitant of a single life-annuity dies. Alternatively, a lump sum distribution may be paid. Since, however, the payment or payments to the beneficiaries are typically based on a predetermined minimum payment duration or total, such as the amount of the paid premium or purchase price, and since the benefit to the beneficiaries is only the value remaining after any disbursements to the annuitant, the distribution to the beneficiary is not certain at least at the inception of the annuity. Annuitants interested in providing a lump sum legacy benefit to a beneficiary that is substantially certain at least at the inception of the annuity without resort to a separate life insurance policy may therefore also shy away from annuities as an investment option.

Additionally, some annuities, for example, variable annuities, allow payments to the annuitant or beneficiary to be tied to a benchmark interest rate, for example, a Constant Maturity Treasury (CMT) rate. For example, a customer may purchase a life-time annuity that pays a then current 1-or 5-year CMT rate per annum for the life of the annuitant or beneficiary. To secure a stream of income payments for the annuitant or beneficiary, the provider of the annuity, such as an insurance company, may simultaneously with the sale of the annuity invest in a corresponding security, for example, a 1-or 5-year U.S. Treasury, that would provide the necessary income stream. As such income providing securities mature, the funds are re-invested into similar securities. As the interest rates fluctuate, however, the income payments of such annuities fluctuate as well. Thus, the annuitant bears re-investment risk. If, for example, five years after the issuance of the annuity, the interest rate on the 5-year CMT drops significantly, as may happen during a recession, the annuitant or beneficiary may end up receiving significantly lower income payments than expected, which may severely impact their standard of living.

Conversely, an annuity tied to a long-term security, such as a 30-year U.S. Treasury, may turn out to be a poor investment in an inflationary or rising interest rate environment. Thus, customers anticipating high inflation or rising interest rates may be reluctant to purchase annuities with income payments fixed for a long term because the beneficiaries of such annuities would be receiving smaller interest payments than the market would then be paying. On the other hand, the very same customers may be wary of investing in annuities whose payments are tied to short-term instruments due to re-investment risks. In sum, customers desire an annuity with greater upside potential but which also includes protection against downside risks.

There is therefore a need for methods and systems for providing annuities with flexible income features and liquidity options that overcome the shortcomings associated with the income features and liquidity options described above and legacy benefits that overcome the shortcomings associated with the legacy benefits that are currently available.

There is also a need for methods and systems for providing annuities with income level reset options that overcome shortcomings associated with the annuity options described above.

A few computerized systems have been adopted in the art with respect to annuities, such as those described in U.S. Pat. No. 5,893,071, entitled “Annuity Value Software,” U.S. Pat. No. 5,933,815, entitled “Computerized Method and System for Providing Guaranteed Lifetime Income with Liquidity,” and U.S. Pat. No. 6,064,969, entitled “Flexible Annuity Settlement Proposal System,” each of which is hereby incorporated herein by reference in its entirety. The systems and methods described therein do not, however, address and/or overcome the shortcomings associated with annuity income features, liquidity options, and legacy benefits.

### SUMMARY OF THE INVENTION

This invention relates to methods and systems that provide, among other things, annuities with flexible income features and income level reset and liquidity options without some or all of the shortcomings associated with annuity income features, fixed income, and liquidity options appearing in the art and legacy benefits without some or all of the shortcomings associated with existing annuity legacy benefits.

In one aspect of the present invention, a flexible income insurance product is provided that allows a consumer to choose two or more different income levels corresponding to two or more distinct phases of retirement. For example, consumers may wish to match their future income payments to the timing of their expected changing income needs. Some consumers who anticipate that they will be more active during their first twenty years of retirement might elect a higher level of payment for those years, and then “step down” their income level in their later, less active retirement years. By contrast, consumers anticipating greater income needs during their later retirement years may elect to “step-up” up their income level after the first twenty years. Alternatively, consumers who wish to tie their future income payments to their expected management of the income and their overall investment portfolio may seek greater income while they are actively managing their portfolio during their early retirement years, and then “step down” their income in their later years, in lockstep with a decreased level of overall investment activity. Others, by contrast, might wish to accept smaller income payments in their early retirement years, and then “step up” their income in their later years, when they are less able to manage their investment portfolio and are more dependent on guaranteed income payments. The step-up percentage may be any percentage, preferably between about 1% and about 400%. The step-down percentage may similarly be any percentage, preferably between about 1% and about 50%.

In one embodiment, a computerized method of providing an annuity including a flexible income feature includes the steps of receiving information useful for issuing an annuity providing a first level of income payments during a first time period and a second level of income payments different than the first payment level during a second time period following the first time period, the second payment level being contingent on a first event, computing an annuity premium necessary to provide the first level of income payments and the contingent second level of income payments, receiving at least a portion of the computed premium and issuing the annuity.

In one embodiment, a method of providing an annuity that includes the steps of obtaining information useful for issuing an annuity, the information including a first level of income payments, a second level of income payments, and at least one income change date, and computing an annuity premium necessary to provide the first level of income payments before the occurrence of the income change date and the second level of income payments after the occurrence of the income change date. The annuity includes a flexible income feature that allows its holder to receive at least two different levels of income payments.

In another aspect of this invention, a method of providing an annuity including a guarantee period is provided that includes the steps of obtaining information useful for issuing an annuity from an individual, and computing either an annuity premium or future income payments based at least partially on the information obtained from the individual. The annuity includes at least one liquidity option, which allows the holder of the liquidity option to exercise the option and convert therewith a portion of a value of the annuity into a liquid asset. In at least one embodiment, the value of the annuity is computed at least in part based on or taking into account the value of the future income payments. The liquidity option may be limited to being exercised and thereby allowing the holder of the option to convert a portion of the value of the annuity into a liquid asset only after the annuity payments begin and/or for a limited number of times.

The conversion may be in a variety of forms, such as in the form of an advance of at least a portion of the future income payments, or a plurality thereof, such as six months of future income payments. In one embodiment, the liquidity option limits the holder's ability to exercise the option to only twice after the annuity payments begin. To account for the advance of the future income payments, future income payments due to the holder of the liquidity option subsequent to the advance may be ceased for a period of time. For instance, where six months of future income payments are advanced, the future income payments will cease for six months subsequent to the advance. Conceptually, the advance may be viewed as a lump sum distribution of six months worth of future income payments in which instance the advance will be of five future income payments and consequently future income payments will cease for a period of five months to account for the distribution.

In some embodiments, the conversion is in the form a lump sum distribution of at least a portion of a commuted value of the annuity, for example 30% of the commuted value, computed based at least in part on the present value, at the time of the conversion, of future income payments that are expected to be paid, e.g., over the remainder of the annuitant's lifetime or the remainder of the guarantee period. In other embodiments, the entire value of a commuted value of the annuity is distributed. The future income payments may be based on the life of the annuitant or beneficiary, in which instance the lump sum distribution of the commuted value of the annuity or a portion thereof is computed based at least in part on the present value, at the time of the conversion, of the future income payments expected to be paid out over the life of the annuitant. The holder of the liquidity option may further be limited in this respect to exercising the liquidity option for a limited number of times, such as once after the annuity payments begin, or at predefined time intervals after the annuity payments begin, such as at about the fifth, tenth, or fifteenth anniversaries of a commencement date to receive income payments, or upon a showing of an occurrence of a predefined event. In some embodiments, such predefined events may include the annuitant's reaching a predetermined age.

In another aspect of the present invention, a method of providing an annuity is provided that includes the steps of obtaining information useful for issuing an annuity from an individual, and computing future income payments based at least in part on a legacy benefit option which provides a lump sum distribution of a portion of an annuity premium to a beneficiary upon the death of the annuitant or annuitants. The lump sum distribution is substantially certain at the inception of the annuity. The lump sum distribution may be in the form of a percentage of an annuity premium, such as about 25% or about 50%. In one embodiment, the guarantee period of the annuity is based on the life of the individual. The future income payments are therefore computed based on a liquid benefit option, which provides a lump distribution of a portion of the annuity as a death benefit to the beneficiary. In one embodiment, the legacy benefit option provides a lump sum distribution to a beneficiary that does not expire during the term of the annuity.

In another aspect of the present invention, a method of facilitating distribution of annuity payments is provided that includes the steps of receiving a demand for a liquid distribution, and computing the liquid distribution according to at least one liquidity option of an annuity. The liquidity option generally allows the holder of the liquidity option to convert a portion of the value of the annuity into a liquid asset, such as cash. The value of the annuity, in at least one embodiment, is computed at least in part based on future income payments, which can include payments that are guaranteed to be paid for the duration of one or more lifetimes.

In one embodiment, the liquid distribution may be in the form of an advance of at least a portion of future income payments, or a plurality thereof, such as an advance of six months of the future income payments. The distribution may also be a lump sum distribution of six months worth of future income payments. The option may be limited with respect to the number of times it may be exercised, such as twice after the annuity payments begin. The method may further include the steps of making the liquid distribution, and ceasing future income payments due to the holder of the liquidity option subsequent to the advance for a period of time to account for the advance of the future income payments. For instance, where an advance of six months of future income payments are made, the future income payments may cease for six months subsequent to the advance or where the advance is for five future income payments, the future income payments cease for a period of five months to account for the lump sum distribution.

In another embodiment, the liquid distribution is made in the form of a lump sum distribution of at least a portion of the commuted value, such as 30% of the commuted value, of the annuity computed based at least in part on the present value, at the time of the conversion, of future income payments that are guaranteed to be paid, e.g., for the remainder of the guarantee period. The future income payments may be based on the life of the annuitant, in which instance the liquid distribution is at least a portion of the commuted value of the annuity computed based at least in part on the present value, at the time of the conversion, of the future income payments expected to be paid out over the life of the annuitant. The right to exercise the liquidity option may be limited to a certain number of times, such as once after the annuity payments begin, and at predefined time intervals after the annuity payments begin, such as at about the fifth, tenth, and fifteenth anniversaries of the commencement of income payments, or upon a showing of an occurrence of a predefined event. In some embodiments, such predefined events may include the annuitant's reaching a predetermined age.

In another aspect of the present invention, a method of providing an annuity with an income level reset option based on interest rate changes is provided. For example, consumers anticipating higher inflation and correspondingly higher interest rates in the future may elect such an income level reset option. If elected, the option provides for an automatic benefit increase if the then current interest rates have risen by a predefined level over a benchmark rate or index, for example, the 10-year Constant Maturity Treasury (CMT) index. In one embodiment, if after a predefined period of time, for example, five years, the benchmark rate, for example, the 10-year CMT index, rises by more than a predefined level, for example, by at least 50 basis points (bp), the income reset option is triggered and the income payments from the annuity are increased accordingly. Thus, for example, the initial payments calculated at three per cent per annum (3% p.a.) may increase to 3.5% p.a. If, however, the benchmark rate remains the same or even drops, the annuitant or beneficiary continues to receive the same level of income payments. In some embodiments, to provide the income level reset option, the annuity makes lower payments to the annuitant or beneficiary for a predefined period of time or a larger costs are charged on issuance of the annuity. In some embodiments, a cap is imposed on a maximum rate increase, for example 500 bp.

In some embodiments, a snapshot of the index rate is taken on an anniversary date, for example the fifth anniversary date, and the income reset option is triggered and the income payments from the annuity are increased only if the snapshot rate exceeds a predefined level. In these embodiments, the income reset option is not triggered and the income payments do not increase, if, for example, the benchmark rate increases significantly in year 3 but then decreases by the time the snapshot is taken in year 5.

In one embodiment, the income level reset option is exercised automatically upon occurrence of a predefined event, for example, at about the fifth, tenth, and fifteenth anniversaries of the commencement of income payments. In some embodiments, such predefined events may include the annuitant's reaching a predetermined age.

In an alternative embodiment, the exercise of the option requires additional authorization from the annuitant or beneficiary. The right to exercise the income level reset option may be limited to a certain number of times, such as once after the annuity payments begin, and at predefined time intervals after the annuity payments begin, such as at about the fifth, tenth, and fifteenth anniversaries of the commencement of income payments.

To fund the income level reset option, the annuity provider may use several methods. In one embodiment, to fund a potential rate increase, the provider invests in any suitable financial instrument, for example, an interest rate option or “swaption,” which allows the provider to effect an interest rate swap on a set date at a pre-agreed rate, principal amount, and term. An upfront premium payable to the swaption seller may be deducted from the annuitant income payments or may be added to the cost of the annuity. In this embodiment, the potential upside for the annuitant may be contractually limited at the time of the annuity issuance to the interest rate option's terms. Thus, for example, if on the 5th anniversary of the annuity, the rate index, preferably the 10-Year CMT, has risen 300 bp or more, the insurance company exercises the interest rate option and the annuitant's income resets from that point forward to the income amount that would have been calculated at issue if rates were 300 bp higher. If rates have not risen by at least 300 bp, then the annuitant's income does not change. One of the advantages of this embodiment is a relatively low cost of the income level reset option to the annuitant. However, as the annuity provider buys an interest rate option at the time of issuance of the annuity, the potential upside for the annuitant, in this embodiment, may be contractually limited to the interest rate option's terms. Thus, if rates rise significantly, the annuitant's income may increase by a fixed percentage, for example, 300 bp, but not more. Additionally, if rates do not rise by the pre-determined percentage, for example, by at least 300 bp, the interest rate option expires without triggering the income level reset option.

In an alternative embodiment, the annuity provider, for example, an insurance company, invests in short-term securities, for example, one or five-year Treasuries, and hedges re-investment risk by purchasing an interest rate option that pays the insurance company if interest rates decline. Every year or five years, as the original investments mature, the insurance company reinvests the funds to support a lifetime payment to the annuitant or beneficiary. If rates have increased, the insurance company reinvests the entire remaining value at the higher rates. If rates have declined, the insurance company reinvests at lower rates and exercises the interest rate option, which provides the funding needed to ensure that the annuitant's income remains the same. One of the advantages of this embodiment is the absence of a pre-defined minimum interest rate increase to trigger the income level reset option—the annuitant's income may be reset higher on multiple occasions after any interest rate increase. Another advantage of this embodiment is unlimited upside for the annuitant. The income level is not capped and the entire benefit of rising interest rates are passed to the annuitant. The cost of income level reset option, in this embodiment, may be significantly higher since the initial income would be based on short-term securities, which usually make lower payments than long-term securities. The cost of the income level reset option may further be exacerbated by a higher cost of the interest rate hedge option. While as in the previous embodiment, the annuitant's income will never drop below a pre-defined level, annuitants will not know in advance by how much their income may rise. To facilitate decision-making by potential customers, the insurance company may compute a breakeven point indicating how much interest rates will need to rise to make the option worthwhile.

In some embodiments of the present invention, income level reset options, flexible income features and liquidity options may be used separately or in various combinations.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flowchart of a method of providing an annuity which includes at least one liquidity option and/or flexible income feature according to one embodiment of this invention;

FIG. 2 is a flowchart of a method of providing an annuity including a flexible income feature according to one embodiment of this invention;

FIG. 3 is a flowchart of a method of providing an annuity with several levels of income payments according to one embodiment of this invention;

FIG. 4a is a flowchart of a method of funding the income level reset option according to one embodiment of this invention;

FIG. 4b is a flowchart of a method of funding the income level reset option according to another embodiment of this invention;

FIG. 5 is a flowchart of a method of facilitating distribution of annuity payments in accordance with at least one liquidity option according to one embodiment of this invention;

FIG. 6 is a flowchart of a method of facilitating distribution of annuity payments in accordance with at least one flexible income feature according to one embodiment of this invention; and

FIG. 7 is a diagram of a system useful for providing an annuity which includes at least one liquidity option, at least one interest rate reset option, and/or flexible income features according to one embodiment of this invention.

### DETAILED DESCRIPTION OF THE PREFERRED EMBODIMENTS

The methods and systems according to the present invention may be applied equally to any type of annuity, such as an immediate annuity, a deferred annuity, a fixed rate annuity, a variable annuity, etc. Therefore, although the methods and systems herein will be discussed by way of example in relation to certain types of annuities, it is understood that the present invention is not limited thereto.

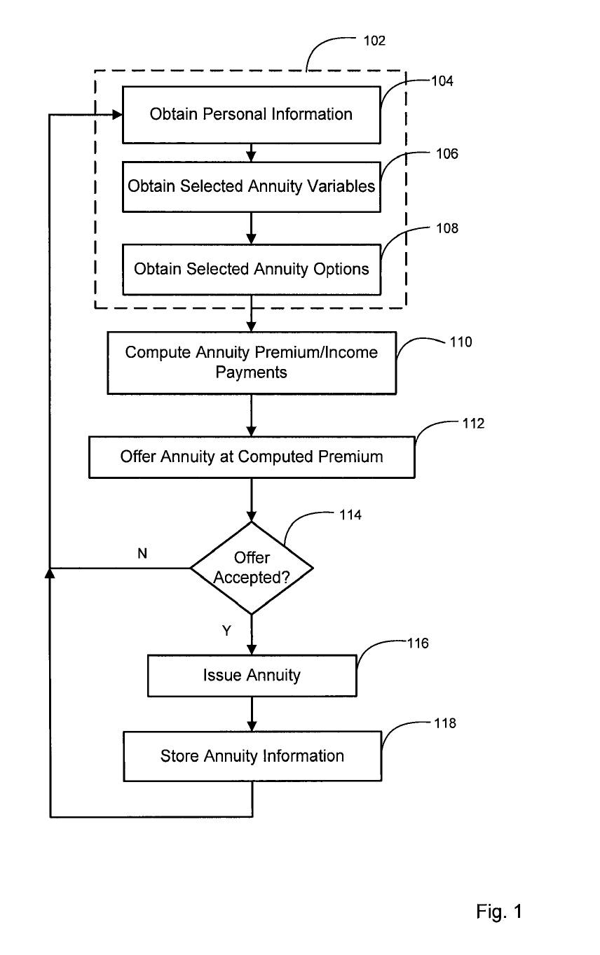

Referring to FIG. 1, a method of providing an annuity with at least one liquidity option, at least one flexible income feature or a rider, and at least one income level reset option based on changing interest rates according to an embodiment of this invention begins at step 102 with obtaining information from an individual or individuals, such as potential annuitants, that is useful for issuing an annuity contract. The nature of the information that is useful in issuing an annuity contract may vary depending on the type of annuity that is being considering by the individual. Such information may generally be classified as personal information, or information regarding variables associated with the annuity or any available annuity options. Thus, the step of obtaining information, may include a plurality of steps, such as obtaining personal information 104, obtaining selected or specified annuity variables 106, and obtaining selected or specified annuity options 108.

The nature of personal information may also vary depending on the type of annuity, and may include information regarding an annuitant's name, age, date of birth, gender, the state or residence, etc. If the annuity includes a co-annuitant or beneficiary, the co-annuitant's and/or beneficiary's personal information may also be obtained. Some personal information may be necessary to compute certain variables associated with annuities, such as to compute the future income payments, the premium or purchase price, etc., and may therefore be required. For example, income payments for an immediate life annuity may be computed based on the annuitant's age and gender.

Information regarding annuity variables may be selected or specified by either the potential annuitant or the insurer. An insurer is used herein to denote the party offering and/or guaranteeing the annuity contract, for example an insurance company. Annuity variables are generally variables that may be used in computing the future income payments or the premium, e.g., the purchase price of the annuity. Annuity variables may therefore differ between different types of annuities. For immediate annuities, for instance, annuity variables may include the premium for the annuity, the desired future income payments, any applicable increases in the periodic payments over time to account for, e.g., inflation, the guarantee period, e.g., life or for a term certain, the applicable interest rates, fees, etc. The insurer will typically specify certain variables, such as the interest rate or rates and any applicable fees. For annuities with at least one flexible income feature or a rider, an annuity variable will include one or more income change dates and corresponding income change percentages. For example, the annuitant may specify or select a premium or purchase price for an immediate annuity of $40,000 that will provide level monthly future income payments for the life of the annuitant at a rate and fees specified by the insurer. Alternatively, the annuitant would specify or select a particular product, for example, a deferred or immediate annuity, and several desired levels of income and corresponding income change dates to the insurer. Such a flexible income feature may be provided as a stand-alone policy or as an optional rider to an existing insurance product. Variables for deferred annuities may further include information regarding the date the annuity matures. In the above example, the potential annuitant may further select the maturity date as the date the annuitant reaches the age of 65, which allows annuitants to make periodic payments or contributions that will amount to the total the price of the annuity.

Annuity options may be specified or selected by either the potential purchaser or the insurer. Annuity options are generally contractual rights conferred under the annuity contract to either party or beneficiary that allows the holder of the right to demand performance or non-performance from one or all of the remaining parties or beneficiaries to the contract. Annuity options, for instance, may be optional features or riders that modify a standard annuity, in which case the annuitant will be able to select from one or more available annuity options. Alternatively, certain annuity options may be standard features of the annuity contract, which will be specified by the insurer. Since annuities are contracts, annuity options may vary in nature and scope limited only by the scope of human ingenuity. Such annuity features or riders may be purchased or issued at issuance of the annuity, at a time subsequent to the issuance of the annuity, or other time.

In one embodiment, the annuity contract includes at least one liquidity option that allows the holder of the option, generally the owner of the annuity which may or may not be the annuitant, and/or the beneficiaries of the annuity, to convert a portion of the value of the annuity computed at least in part based on the value of future income payments, which may be lifetime dependent, into a liquid asset, such as cash. The value of the future income payments generally takes into account the value of the annuity with respect to the expected amount of the future income payments for the guarantee period, which may include the lifetime of the annuitant or annuitants. The liquidity option may further allow the owner and/or beneficiary to retain the right to future income payments after the liquid option has been exercised for any remainder of the period over which payments are guaranteed to be made, which may include the lifetime of the annuitant or annuitants. The conversion may occur before and/or after the owner elects to begin receiving annuity payments and may be in the form of advanced future income payments or a lump sum distribution of a portion of the value of the annuity.

To provide an annuitant with a greater income potential at relatively low cost and without a corresponding income reduction risk, in some embodiments, the annuity contract includes at least one income level reset option based on interest rate changes, which may be appealing to those potential customers who anticipate higher inflation and correspondingly higher interest rates in the future. The option provides for an automatic income payment increase if, after a specified time, interest rates have risen by a predefined level over a benchmark rate or index, for example, the 10-year Constant Maturity Treasury (CMT) index as of the time of issuance. If after a predefined period of time, for example, five years, the benchmark rate, for example, the 10-year CMT index, rises above the rate at issuance of the annuity product by more than a predefined level, for example, by at least 50 basis points (bp), the income level reset option is triggered and the income payments from the annuity are reset to an increased amount from that point forward, based on the income payment which would have been calculated at issuance had the interest rate at issuance been higher in the amount of the predefined level of increase. If, however, after a predefined period of time, for example, five years, the benchmark rate, for example, the 10-year CMT index, remains the same or even drops, the annuitant or beneficiary continues to receive the same level of income payments. To provide the income level reset option, the annuity makes payments to the annuitant or beneficiary for a predefined period of time which are lower than the payments would have been without the reset option, or the annuitant is charged more at issuance of the annuity.

Thus, for example, an annuitant purchases a life-time annuity with a face value of $1,000,000 and initial payments tied to the 10-year CMT index which, at the time of issuance, yields three per cent per annum (3% p.a.). The annuity will initially pay $30,000 annually. If, after five years, the yield on the 10-year CMT index rises by 50bp to 3.5% p.a., the income level reset option is triggered and the income payments increase to 3.5% p.a. or $35,000. If the annuitant chooses to fund the income level reset option from initial interest payments, the first five annual payments are reduced to account for the cost of the interest rate option, for example, by $2,000 per annum. Thus, whereas a holder of a conventional annuity would receive $30,000 per annum for life, a holder of an annuity with an income level reset option would receive $28,000 per annum for the first five years and $35,000 per annum for the remaining life of the annuitant. In some embodiments, the annuitant may choose to fund the income level reset option over the life of the policy.

In some embodiments, the income level reset option is exercised automatically upon occurrence of a predefined event, for example, at about the fifth, tenth, or fifteenth anniversaries of the commencement of income payments. In some embodiments, such predefined events may include the annuitant's reaching a predetermined age. In an alternative embodiment, the exercise of the option may require authorization from the policy owner, annuitant, or a beneficiary. The right to exercise the income level reset option may be limited to a certain number of times, such as once after the annuity payments begin, and at predefined time intervals after the annuity payments begin, such as at about the fifth, tenth, and fifteenth anniversaries of the commencement of income payments or at time of issue.

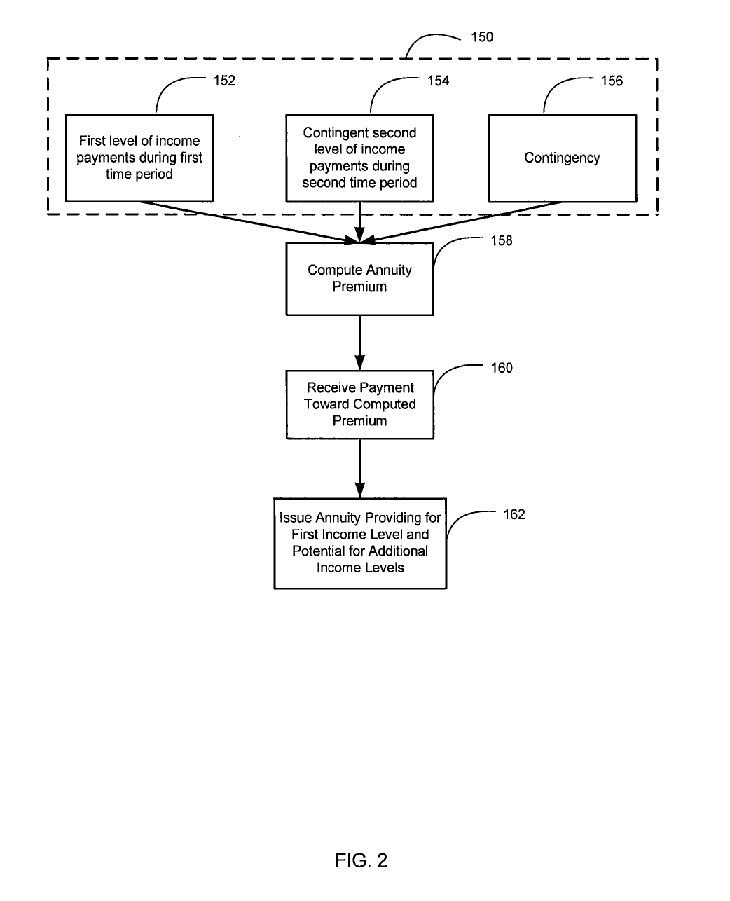

Referring to FIG. 2, a method of providing an annuity with the potential for several levels of income payments according to an embodiment of this invention begins at 150 with receiving information that is useful for issuing an annuity. The step of receiving information includes obtaining a first level of income payments payable during an associated first time period at 152, obtaining a second level of income payments payable during an associated second time period at 154, and obtaining at least one contingency event at 156. In this embodiment, the second level of income payments is different than the first payment level and is contingent on the occurrence of a pre-defined event. Such contingent events may include a specified date, for example, a specified anniversary of the commencement of income payments, the annuitant or beneficiary reaching a specified age, or any specified contingent event, for example, interest rate changes, a period of hyper-inflation exceeding a specified level. After receiving the annuity information at 150, an annuity premium necessary to provide the first level of income payments and the contingent second level of income payments is computed by a computer at 158; the computed premium or at least a portion thereof is received at 160, and the annuity providing for a first income level and potential additional levels of income payments is issued at 162.

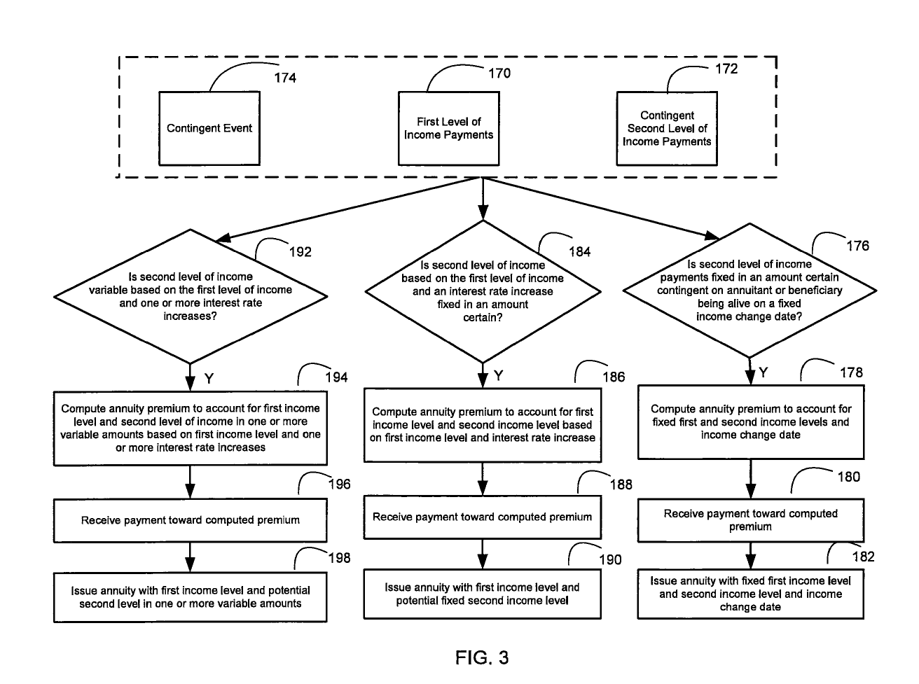

Referring to FIG. 3, methods of providing annuities with varied levels of income payments according to an embodiment of this invention begins with obtaining information which is useful for issuing an annuity, including obtaining a first level of income payments at 170, obtaining a contingent second level of income payments which may or may not be fixed at 172, and at least one contingency at 174. Several determinations are made with regard to the received annuity information before an annuity premium is computed by the computer. Thus, if at 176, it is determined that the second level of income payments is fixed in an amount certain and is contingent on the annuitant or beneficiary being alive on the contingency date, for example, a fixed income change date, then the corresponding annuity premium is computed by the computer at 178, the computed premium is received at 180, and the annuity with fixed first income level and second income level that is contingent on the annuitant being alive on the income change date is issued at 182.

If, at 184, it is determined that the second level of income is based on the first level of income and is contingent on an interest rate increase in an amount certain, then the corresponding annuity premium is computed by the computer at 186, the computed premium is received at 188, and an annuity with the first income level and the potential fixed second income level which is contingent on the interest rate increase, is issued at 190.

If, at 192, it is determined that the second level of income is based on the first level of income and is contingent on one or more interest rate increases, then the corresponding annuity premium is computed by the computer at 194, the computed premium is received at 196, and an annuity with the first income level and the potential second income level in one or more variable amounts, which is contingent on the one or more interest rate increases, is issued at 198.

To fund the income level reset options such as those described above and other embodiments of the invention, the annuity provider, for example, an insurance company, may use several methods. In one embodiment, to fund a potential income increase, in addition to investments the annuity provider makes to fund the annuity without an income level reset option, the provider invests in any suitable financial instrument, for example, an interest rate option, such a “swaption,” which allows the provider to effect an interest rate swap on a set date at a pre-agreed rate, principal amount, and term. An upfront premium payable to the swaption seller may be deducted from the annuitant's income payments or may be added to the cost of the annuity. In this embodiment, the annuitant's income is set at the time of the annuity issuance to correspond to the interest rate option's terms. Thus, for example, if on the 5th anniversary of the annuity, the rate index, preferably, the 10-Year CMT, has risen 300 bp or more, the annuity provider exercises the interest rate option and the annuitant's income resets from that point forward to the income amount that would have been calculated at issuance of the annuity if rates were 300 bp higher. If rates have not risen by at least 300 bp, or if interest rates go down, then the annuitant's income does not change. One of the advantages of this embodiment, is a relatively low cost of the income level reset option to the annuitant. An additional advantage is the relative certainty provided to the annuitant who will know in advance what the income payments will be should interest rates rise to the pre-determined percentage level set in the annuity. However, as the annuity provider buys an interest rate option at the time of issuance, the potential upside for the annuitant is contractually limited to the interest rate option's terms. Thus, if rates rise above the pre-determined percentage level set in the annuity to trigger the rate reset, the annuitant's income is increased by the pre-determined percentage, for example 300 bp, but not more. Additionally, if rates do not rise enough to meet the pre-determined percentage, for example, by at least 300 bp, or if interest rates go down, the income level reset option is not triggered and the annuitant's income payments are not increased.

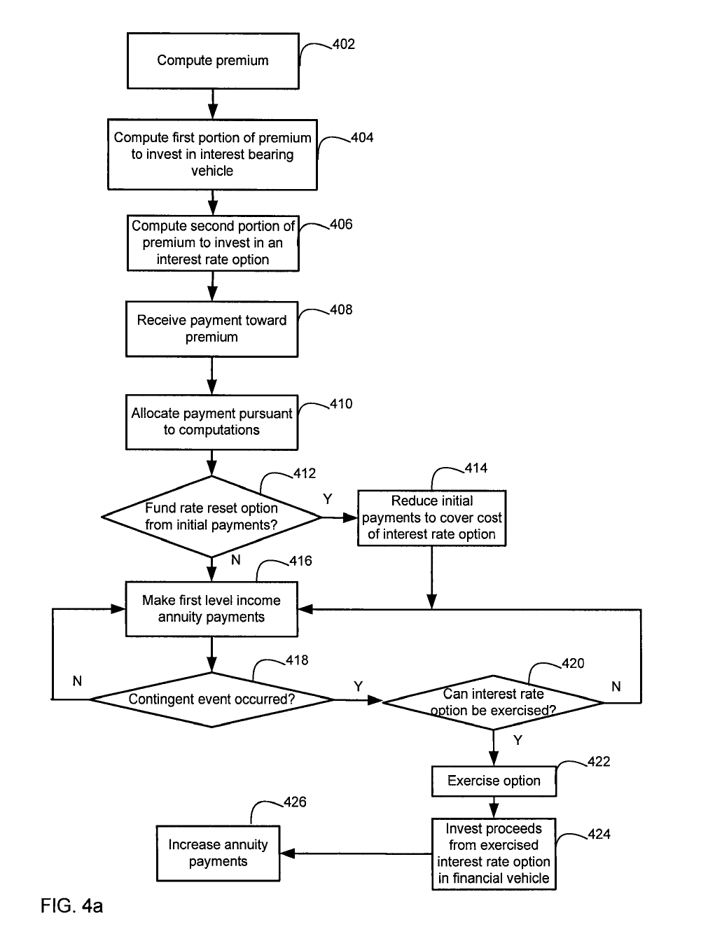

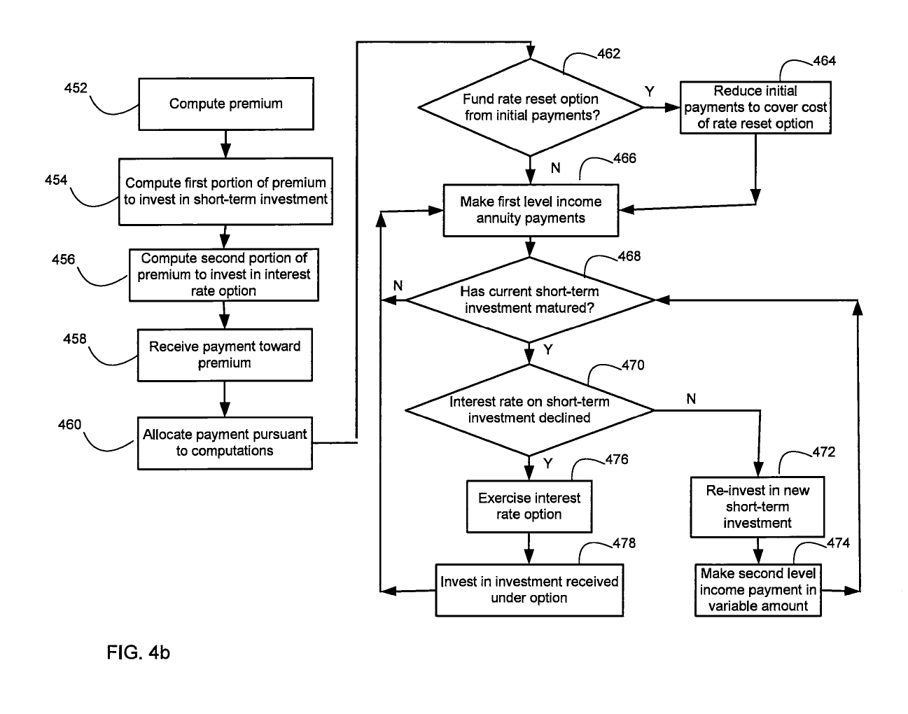

Referring now to FIG. 4a, a method of funding the income level reset option based on interest rate changes according to an embodiment of this invention begins with a computer computing an annuity premium at 402. A first portion of the premium to be invested in an interest bearing vehicle, such as a Treasury, a synthetic bond, or any other interest bearing financial instrument or an asset, is determined at 404. At 406, a second portion of the premium to be invested in an interest rate option, for example, a swaption, is determined. The annuity premium and the foregoing portions may be computed using any suitable formulas. For example, for a fully life contingent annuity:
Net Premium (NP)=Gross Premium−Premium Tax−Policy Fee
NP=Income x aₓ where:

$${a}_{x} = {\sum }_{t = m}^{∞} ( {v}_{t} ) ( {}_{t}^{}{p}{}_{x}^{} )$$

and
t=time from issue (in months); t=0, 1, 2, 3, . . .
iₜ=annual crediting rate applicable t months after policy date
V₍ₜ₎=(1+i_{(g+t)})⁻⁽^{^{t}}^{/}^{₁₂₎} for (g+t)<361
V₍ₜ₎=(1+i₃₆₀)⁻^{^{(360−g)}}^{/}^{₁₂} ×(1.045)⁻^{^{(g+t−360)}}^{/}^{₁₂} for (g+t)>360
V_{(d)}=(1+i₍₁₎₎⁻⁽^{^{d}}^{/}^{₃₆₅}⁾
x=Issue age of annuitant
qₓ₊ₜ=(Mortality for age last birthday for age x+t)×u×(Mortality Projection)^{h}

$${p}_{x + t} = 1 - \frac{1 - {( 1 - {q}_{x + t} )}^{1 / 12}}{{( 1 - {q}_{x + t} )}^{1 / 12}}$$

$${q}_{x + t} = 1 - {p}_{x + t}$$

$${}_{t}^{}{p}{}_{x}^{} = {\prod }_{s = 0}^{t} {p}_{x + s}$$

In some embodiments, for calculating the premium with an income level reset option, the benefit payments are assumed to be level, but the crediting rates (iₜ) would be lower than if calculating the premium for a non-reset option benefit payment. These lower crediting rates account for the cost of purchasing an interest rate option

At 408, at least a portion of the calculated premium is received and at 410 is allocated pursuant to the computations made by the computer at 404 and 406. In some embodiments, to reduce the upfront cost of the annuity, the annuitant may choose to fund the income level reset option out of the initial payments. If it is determined at 412 that such a funding option was selected, then at least one initial payment is accordingly reduced at 414. At 416, the annuitant begins to receive the first level payments under the annuity, some of which may be reduced. At 418, it is determined whether a contingent event, for example, a pre-defined date has occurred or an interest rate level has been reached. At 420, it is determined whether the interest rate option can be exercised. Thus, for example, if on the 5th anniversary of the annuity, the rate index has risen 300 bp or more, the interest rate option is exercised at 422 and the proceeds from the exercise of the option are invested at 424 to provide increased annuity payments at 426. If the contingent event has not occurred, for example, interest rates do not rise enough to meet a pre-determined percentage, for example, by at least 300 bp, or if interest rates go down, the interest rate option is not exercised and the annuitant will continue to receive the first level income payments at 416. In another aspect of this embodiment, the annuitant may choose an annuity that provide for more than one income level reset options, for example, the first income level reset option can be exercised at the 5th anniversary and the second at 10^{th} anniversary of the annuity, in which case the steps 418-426 are repeated. Otherwise, the annuitant continues to receive the first level income payments for a specified period of time, for example, for life. In some embodiments, the interest rate option entitles the annuity provider to swap a lower-interest rate financial vehicle for a higher-interest rate financial vehicle, in which case the investment of proceeds at 424 is not needed.

In an alternative embodiment, the annuity provider, for example, an insurance company, invests in short-term securities, for example, one or five-year Treasuries, and hedges re-investment risk by purchasing an interest rate option that pays the insurance company if interest rates decline. Every year or five years, as the original investments mature, the insurance company reinvests the funds to support a lifetime payment to the annuitant or beneficiary. If rates increase, the insurance company reinvests the entire remaining value at the higher rates. If rates decline, the insurance company reinvests at lower rates and exercises the interest rate option, which provides the funding needed to ensure that the annuitant's income remains the same. One of the advantages of this embodiment is that the annuitant receives the benefit of any interest rate increase; there is no pre-defined minimum interest rate increase required to trigger the income level reset option and the annuitant's income is increased after any interest rate increase. There is thus no limit to the potential upside for the annuitant. The income level reset is not capped as the entire benefit of rising interest rates are passed onto the annuitant. An additional advantage is that the annuitant's income will not go down.

The cost of rate reset option, in this embodiment, may be higher since the initial income is based on short-term securities, which usually make lower payments than long-term securities. The cost of this income level reset option may be exacerbated by a higher cost of the interest rate hedge option. While, as in the previous embodiment, the annuitant's income will never drop below a first level, annuitants will not know in advance by how much their income may rise. To address this uncertainty and facilitate decision-making by potential customers, the annuity provider may compute a breakeven point indicating how much interest rates will need to rise to make the income level option worthwhile.

Referring now to FIG. 4b, a method of funding the rate reset option according to an alternative embodiment of this invention begins with a computer computing an annuity premium at 452. A first portion of premium to be invested in an interest bearing vehicle, for example, a short-term security, such as a T-bill, is determined at 454. At 456, a second portion of the premium to be invested in an interest rate option is determined. In this embodiment, such an interest rate option provides a “floor hedge” guaranteeing minimum interest payments in case the interest rates drop. Preferably, such minimum interest payments cover the first level of income payments payable under the annuity. The annuity premium and the foregoing portions may be computed using any suitable formulas. For example, for a fully life contingent annuity:
Net Premium (NP)=Gross Premium−Premium Tax−Policy Fee
NP=Income x aₓ where:

$${a}_{x} = {\sum }_{t = m}^{∞} ( {v}_{t} ) ( {}_{t}^{}{p}{}_{x}^{} )$$

and
t=time from issue (in months); t=0, 1, 2, 3, . . .
iₜ=annual crediting rate applicable t months after policy date
V₍ₜ₎=(1+i_{(g+t)})⁻⁽^{^{t}}^{/}^{₁₂₎} for (g+t)<361
V₍ₜ₎=(1+i₃₆₀)⁻^{^{(360−g)}}^{/}^{₁₂} ×(1.045)⁻^{^{(g+t−360)}}^{/}^{₁₂} for (g+t)>360
V_{(d)}=(1+i₍₁₎₎⁻⁽^{^{d}}^{/}^{₃₆₅}⁾
x=Issue age of annuitant
qₓ₊ₜ=(Mortality for age last birthday for age x+t)×u×(Mortality Projection)^{h}

$${p}_{x + t} = 1 - \frac{1 - {( 1 - {q}_{x + t} )}^{1 / 12}}{{( 1 - {q}_{x + t} )}^{1 / 12}}$$

$${q}_{x + t}^{′} = 1 - {p}_{x + t}$$

$${}_{t}^{}{p}{}_{x}^{} = {\prod }_{s = 0}^{t} {p}_{x + s}$$

In some embodiments, for calculating the premium with an income level reset option, the benefit payments are assumed to be level, but the crediting rates (iₜ) would be lower than if calculating the premium for a non-reset option benefit payment. These lower crediting rates account for the cost of purchasing an interest rate option

At 458, at least portion of the calculated premium is received and at 460 is allocated pursuant to the computations made at 454 and 456. In some embodiments, to reduce the upfront cost of the annuity, the annuitant may choose to fund the income level reset option from initial payments. If it is determined at 462 that such an option was selected, then at least one initial payment is accordingly reduced at 464. At 466, the annuity begins to pay the first level payments under the annuity, some of which may be reduced. At 468, it is determined whether the current short-term investment matured. If not, then the first level payments funded by the current short-term investment are continued; otherwise, at 470 it is determined whether the interest rate on available short-term investments has declined. If the rates have not declined, then the funds are re-invested in a new short-term investment at 472 and the annuity begins to pay a second level income payments in a variable amount funded by a new interest rate. In this embodiment, the amount by which the second level of income payments may go up is not pre-defined. Thus, the second level income payments may stay the same, if the interest rate on the short-term investment has not changed. The annuitant will capture any increase in the short-term rate which occurs after the current short-term investment expires. Beneficially, such interest rate resets can be set up to occur quite often, for example, annually, provided however, the annuitant is willing to bear the cost of corresponding interest rate options or to bear the risk of interest rate declines, if the number of interest rate options the annuitant chose to purchase has been used up.

If at 470 it is determined that the interest rate has declined, the interest rate option is exercised at 476. For example, as a result of the option exercise, the annuity provider may be able to invest in a long-term security that pays at least the first level of income payments. Thus, the annuitant continues to receive the first level of annuity income payments at 466 for a pre-defined period, for example, for life.

In another aspect of this embodiment, the annuitant may choose an annuity that provides for more than one income level reset option, for example, the annuity specifies that the first income level reset option can be exercised at the 5th anniversary of the annuity and the second interest rate reset option can be exercised at 10th anniversary of the annuity, in which case the annuity provider may first invest in a five-year investment while simultaneously investing in an interest rate hedge that can be exercised in five years and guarantees the first level of income payments. After five years, if the interest rate went up, the provider re-invests in the second five-year investment that pays higher interest while simultaneously investing in a second interest rate hedge that can be exercised in five years and guarantees the second level of income payments. Otherwise, the first interest rate hedge is exercised and the annuitant continues to receive the first level payments for another five years. In these embodiments, the annuitant pays for the second interest rate hedge either upfront or through the reduction of second level income payments. On the 10 ^{th} anniversary of the annuity, if the interest rate increases yet again, the provider re-invests the proceeds received from the second five-year investment that has matured into a long-term asset so that the second level of income payments in variable amounts is paid to the annuitant for a pre-defined period of time, for example, for life. If the interest rate went down, the provider exercises the second hedge thereby securing the provision of the second level of payments for the annuitant.

In another aspect of the present invention, the rigidity of a fixed annuity payment is resolved to provide a consumer with greater flexibility of annuity income options based on each consumer's anticipated retirement needs. Thus, the annuity contract includes at least one flexible income feature or a rider that allows the holder of the option, generally the owner of the annuity which may or may not be the annuitant, and/or the beneficiaries of the annuity, to choose two or more different income levels corresponding to two or more distinct phases of retirement. For example, consumers may wish to match their future income payments to the timing of their expected changing income needs. Consumers who anticipate that they will be more active during their first twenty years of retirement might elect a higher level of payment for those years, and then “step down” their income level in their later, less active retirement years. By contrast, consumers anticipating greater income needs during their later retirement years may elect to “step-up” up their income level after the first twenty years. Alternatively, consumers who wish to tie their future income payments to their expected management of the income and their overall investment portfolio may seek greater income while they are actively managing their portfolio during their early retirement years, and then “step down” their income in their later years, in lockstep with a decreased level of overall investment activity. Others, by contrast, might wish to accept smaller income payments in their early retirement years, and then “step up” their income in their later years, when they are less able to manage their investment portfolio and are more dependent on guaranteed income payments. The step-up percentage may be any percentage, preferably between about 1% and about 400%. The step-down percentage may similarly be any percentage, preferably between about 1% and about 50%.

To facilitate the provider's ability to offer a flexible income rider (also referred to herein as a changing needs rider), in some embodiments, the rider may be offered with or subject to specific restrictions designed to maximize the value of offering the rider to the provider and to keep the premiums for the rider low enough to be desirable to consumers. If a customer purchases a policy with lower income payments in the earlier year relative to the level payment, or if a customer starts with the income payments that are same as the level payment and chooses to reset to a lower amount relative to the level payment, in some embodiments, the required initial premium will be lower relative to the level payment option.

In some embodiments, the provider will set minimum or maximum ages for when a consumer can purchase the flexible income rider (also referred to as changing needs rider) or minimum or maximum ages that a consumer may be when a new income level takes effect. For example, the minimum consumer age at the time of a first income payment under a flexible income rider would be the expected retirement age (e.g., 59½). In other embodiments, the maximum age a consumer could be to purchase a flexible income rider and the income change date would be set to correspond to an age where it would be expected that a consumer's income needs would change, or would not be expected to change after such time, or based on the then current life expectancy. For instance, the maximum age for purchasing a rider would be 80, and/or the income change date would have to be exercised by age 90, The age minimums and maximums for a flexible income rider may be different than that of a contract without a flexible income rider.

Other specifications relating to the flexible income rider may be desirable but not required, such as limitations on when the income change date and percentages may be chosen, or how many changes may be selected and when. For example, in one embodiment, only one step-up or step-down income level change is permitted for the term of the contract, and the change is only permitted after a period of time after the first income payment on the contract (e.g., on or after the third anniversary of the first income payment). To provide certainty for the annuity provider and the consumer, some embodiments will require that the exact date and percentage of the income change be chosen at issuance of the contract, and prohibit changes to the date and percentage after the contract is issued. For ease of administration, in some embodiments the annuity provider will require that the income change date occur on a specific date in the life of the contract, such as a scheduled payment date, and/or may prohibit changes to the payment mode selected at issuance of the contract.

Other specifications by the annuity provider may be made, consistent with the scope of the invention. For instance, the annuity provider may choose to limit the selection of contract options that would otherwise be available to a consumer, which options would be considered superfluous or, if offered with the changing-needs rider, would make the cost of the annuity product unreasonably high. Thus, in some embodiments, the annuity provider will not make cost-of-living adjustments (COLA) available on contracts that have chosen a flexible income rider.

With regard to the advanced future income payment embodiment, a holder of the right to exercise the option may demand from the insurer an advance of future income payments or a portion thereof. Although the number of times the advanced payment option may be exercised and the magnitude of the advance may be unlimited, an insurer may limit the holder's rights in this respect. For instance, the insurer may limit the number of times the option may be exercised, such as once, twice, etc., and may limit the amount of the advance in terms of a dollar amount, an income period, e.g., six months of income, or a plurality of future income payments, e.g., five or six monthly future income payments. The insurer may further limit the right to exercise the option until after the annuity payments have begun.

In one embodiment, after the advance is distributed, subsequent future income payments will not be distributed for a period of time to account for the advance. Thus, for example, an advance of six monthly future income payments may cause the future income payments to cease for the six months for which the advance was taken. Conceptually, the advance may be viewed as a lump sum distribution of six months worth of future income payments in which instance the advance will be of five future income payments and consequently future income payments will cease for a period of five months to account for the distribution. The insurer faces a risk associated with the advance in the event the insured dies before the advance is accounted for, which may be offset with a fee or other measure. In some embodiments, the insurer has a right to recover the advance payment upon the annuitant's death.

In one embodiment, the mortality risk is born solely by the insurer without a corresponding transfer of the risk to the annuitant in terms of higher fees or costs above a basic annuity without the option. In another embodiment, the right to exercise the option is not contingent on collateral circumstances, such as illness, catastrophic events, etc., and may be freely be exercised by the holder subject to any numerical limitations on the number and magnitude of the advance set forth in the annuity.

With regard to the lump sum distribution of the value of the annuity embodiment, a holder of the right may demand a portion of a commuted value of the annuity measured based at least partially on the present value at the time of the conversion of future income payments for the remainder of the guarantee period, such as for the term certain, e.g., 5, 10, 15, etc. years, or for the life expectancies of the annuitants and/or beneficiaries. Thus, the owner may demand a lump sum distribution commensurate with the value of the future income payments for the duration of the guarantee period, which may include the lifetime of the annuitant or annuitants. The scope of the demand under this option may also be limited by the insurer. The insurer, for instance, may limit the number of times the right may be exercised, such as once, twice, etc., and may limit the right to exercise the option except at certain times during the term of the annuity, such as at the fifth, tenth, and fifteenth anniversaries of a predefined date, such as the date of the commencement of income payments, or upon a showing of the occurrence of certain predefined events, such as fire, flood, illness, etc. In some embodiments, such predefined events may include the annuitant's reaching a predetermined age. The insured may further limit the magnitude of the demand in terms of a dollar amount, a percentage of the commuted value of the annuity, for example, 20%, 30%, 40%, 50%, or 100%. In one embodiment, upon distribution of the payment under this option, future income payments will be adjusted to account for any distribution. A fee or a surcharge may account for the risk associated with this lump sum distribution liquidity option to the insurer, assessed in connection with the lump sum distribution or reflected in the price of the annuity.

In another embodiment, a liquid legacy benefit option is available that may be selected or specified by the potential owner or purchaser that provides a lump sum distribution to a beneficiary upon the death of the annuitant or annuitants that is substantially certain at the inception of the annuity contract. In another embodiment, the liquid legacy benefit option, which provides a lump sum distribution to a beneficiary, is permanent or does not expire at any time during the term of the annuity. The lump sum distribution may be specified in terms of a dollar amount, a percentage of the price of the annuity, a number of future income payments, etc. For example, the potential annuitant may specify a lump sum distribution that is 25% or 50% of the premium or purchase price of the annuity. Thus, the beneficiary of an annuity including a premium of $40,000 and a liquid death benefit of 25% will receive a lump sum distribution upon the passing of the annuitant of $10,000. A liquid death benefit option may be accounted for, for example, by computing future income payments based at least in part on the liquid legacy benefit option, which generally tends to reduce the future income payments otherwise due the annuitant upon the election to receive annuity income payments.

The information that is useful for issuing an annuity contract may be obtained by any one of a variety of methods. A purchaser of the annuity, for example, may give the information in person to a broker or an agent acting on behalf of the insurer who will use the information to compute a price for the annuity or compute estimated future income payment amounts based at least partially on the information obtained. Alternatively or in addition, the potential purchaser may relay the information to a remote agent, broker, or insurer with automated means, such as with personal computer or other device capable of communicating the information to the respective party for processing. Potential purchasers, for example, may communicate the relevant information via email or other forms of text messaging, or via an insurers World Wide Web site which will provide an interface for potential annuitants to communicate specific information to the insurer.

After the information is obtained from the potential purchaser and/or procured by the insurer, a premium for a specified or desired future income payment, which may include at least one flexible income rider, or the future income payments for a specified or desired premium, may then be computed based at least partially on the information obtained. Additionally, for a deferred annuity, the periodic contribution necessary to total the premium may also be computed. The premium or the future income payments may be computed using standard equations and/or actuarial data known in the art with regard to annuities. Computation may be performed with a variety of manual and/or automated means. In one embodiment, the monthly future income payments for a life annuity including the lump sum death benefit option is computed with the following algorithm:

$$B = \frac{( Premium \times ( 1 - T ) - F ) - ( k \times Premium \times {A}_{x} )}{{a}_{x}}$$

where:
B=monthly future income payment at issue
T=premium tax (if applicable)
F=policy fee
k=lump sum reduction factor
x=issue age (in years)
Aₓ=net single premium per unit of death benefit for issue age x
aₓ=present value of a life annuity for issue age x
The lump sum reduction factor, k, is a ratio based on the percentage of the premium that may be distributed as to a beneficiary. In one embodiment, k is equal to 0.25 for a 25% lump sum death benefit and 0.55 for a 50% lump sum death benefit. The values for the net single premium per unit of death benefit for issue age x, Aₓ, and the present value of a life annuity for issue age x, aₓ, may further be computed with the following formulas:

$${A}_{x} = {\sum }_{t = 0}^{( 115 - x ) x 12} ( {}_{t}^{}{p}{}_{x}^{} \times {q}_{x + t} \times {v}^{t} )$$

$${a}_{x} = {\sum }_{t = 0}^{( 115 - x ) x 12} ( {v}^{t} \times {}_{t}^{}{p}{}_{x}^{} )$$

$${}_{t}^{}{p}{}_{x}^{} = {\prod }_{t = 0}^{n} {p}_{x + t}$$

where:
t=time from issue (in months); t=0, 1, 2, 3, . . . n
ₜpₓ=probability person age x survives to time t
qₓ₊ₜ=probability person age x+t does not survive one month
pₓ₊ₜ=probability person age x+t survives one month
iₜ=annual crediting rate applicable t months after policy date
V₍ₜ₎=(1+i_{(g+t)})⁻⁽^{^{t}}^{/}^{₁₂₎} for (g+t)<361
V₍ₜ₎=(1+i₃₆₀)⁻^{^{(360−g)}}^{/}^{₁₂} ×(1.045)⁻^{^{(g+t−360)}}^{/}^{₁₂} for (g+t)>360
V_{(d)}=(1+i₍₁₎₎⁻⁽^{^{d}}^{/}^{₃₆₅}⁾
x=Issue age of annuitant
qₓ₊ₜ=(Mortality for age last birthday for age x+t)×u×(Mortality Projection)^{h}

$${p}_{x + t} = 1 - \frac{1 - {( 1 - {q}_{x + 1} )}^{1 / 12}}{{( 1 - {q}_{x + t} )}^{1 / 12}}$$
qₓ₊ₜ=1−pₓ₊ₜ

In some embodiments, the premium for a fully life contingent annuity including at least one flexible income feature may be computed using the following formulas:
Net Premium (NP)=Gross Premium−Premium Tax−Policy Fee
NP=Income x aₓ where:

$${a}_{x} = {\sum }_{t = m}^{∞} ( {B}_{t} ) ( {v}_{t} ) ( {}_{t}^{}{p}{}_{x}^{} )$$

$$and$$

$$\begin{matrix}CN {\%}_{t} = Changing Needs R ider Percentage at time t . \\ = 0 during the initial benefit period \\ = x \% from the month t when income payments are \\ scheduled ot increased \text{/} decrease\end{matrix}$$

$$\begin{matrix}{B}_{t} = Benefit Income payable at time “ t ” for an annuity \\ starting with an initial benefit of \$1 . \\ = ( 1 + CN {\%}_{t} ) if income is paid at time “ t ” \\ = 0 otherwise ,\end{matrix}$$

where:
t=time from issue (in months); t=0, 1, 2, 3, . . . n
ₜpₓ=probability person age x survives to time t
qₓ₊ₜ=probability person age x+t does not survive one month
pₓ₊ₜ=probability person age x+t survives one month
iₜ=annual crediting rate applicable t months after policy date
V₍ₜ₎=(1+i_{(g+t)})⁻⁽^{^{t}}^{/}^{₁₂₎} for (g+t)<361
V₍ₜ₎=(1+i₃₆₀)⁻^{^{(360−g)}}^{/}^{₁₂} ×(1.045)⁻^{^{(g+t−360)}}^{/}^{₁₂} for (g+t)>360
V_{(d)}=(1+i₍₁₎₎⁻⁽^{^{d}}^{/}^{₃₆₅₎}
x=Issue age of annuitant
qₓ₊ₜ=(Mortality for age last birthday for age x+t)×u×(Mortality Projection)^{h}

$${p}_{x + t} = 1 - \frac{1 - {( 1 - {q}_{x + t} )}^{1 / 12}}{{( 1 - {q}_{x + t} )}^{1 / 12}}$$

$${q}_{x + t}^{′} = 1 - {p}_{x + t}$$

In one embodiment, the exact date and corresponding percentage of income change must be specified at issuance and cannot be changed after the contract is issued; the payment mode selected at issue cannot be changed. In another embodiment, dates, percentages, and modes and types of payments may be adjusted during the life of the contract. In other embodiments, a single step-up or step-down event per contract life is specified. The increase or decrease may occur on or after the third anniversary of the annuity start date, i.e., the date of the first income payment. The step-up percentage may be any percentage, preferably between about 1% and about 400%. The step-down percentage may similarly be any percentage, preferably between about 1% and about 50%. Additionally, cost of living adjustments may be available for regular and/or step-up or step-down income payments.

The computed premium and/or the future income payments may then be presented to the user in the form of an offer to purchase the annuity, step 112. If at step 114 the individual does not accept the offer to purchase the annuity, the information obtained is either saved, such as on the computer system described below, for future reference or discarded, and the methods described above can be repeated for the next potential purchaser. If the individual to whom the offer was made accepts the offer, the annuity will issue at the computed or specified premium or purchase price, step 116. The steps required to issue an annuity vary depending on the nature of the individual that obtained the information. For example, where the insurer or a party authorized to act on behalf of the insurer obtained the information, the annuity will issue automatically or at some predetermined time thereafter, e.g., 30 days, etc. If however the individual is an insurance agent with limited authority to bind the insurer, the annuity will issue only after first being reviewed and accepted by the insurer. Similarly, conditions can be imposed by the insurer, such as a physical, etc., that must be satisfied before the annuity issues. In any event, if the annuity issues, the information obtained, such as the personal information, annuity variables, and annuity adoptions, and any other relevant information are stored in an appropriate database, step 118, such as an annuitant database.

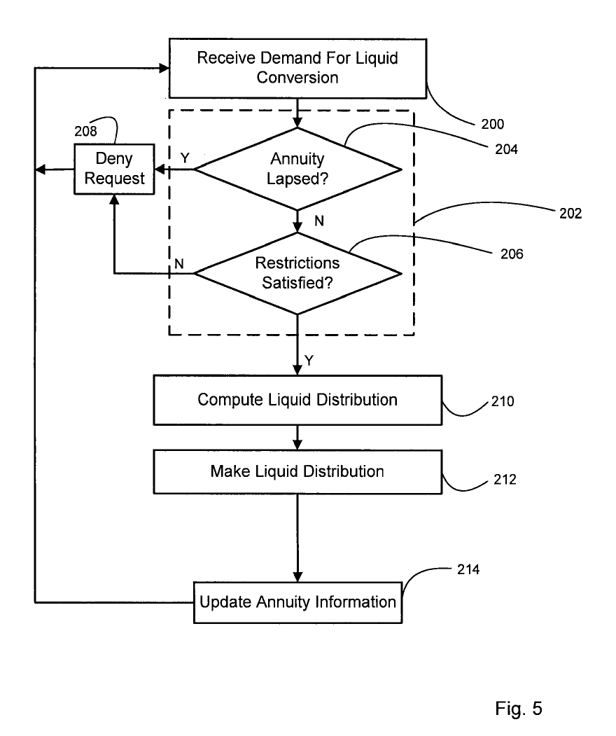

Referring to FIG. 5, a method of facilitating distribution of annuity payments in accordance with at least one liquidity option begins, in one embodiment, at step 200 with receiving a demand exercising at least one liquidity option of an annuity contract. The demand may be received from the holder of the right under the annuity contract in a variety of ways, including a hard copy demand or an electronic version thereof. The demand will then be tested at step 202 with the limitations set forth in the annuity for which the demand is being exercised, and any corresponding information related thereto. Testing the demand 202 generally denotes determining whether or not to allow the demanding party to convert at least a portion of the value of an annuity into a liquid asset, such as cash.

In one embodiment, testing includes determining whether or not the annuity is in effect or has otherwise lapsed, step 204. In another embodiment, testing includes determining whether or not any limitation or restriction that must be satisfied prior to any distribution is satisfied, step 206. Testing will vary depending on the type of the liquidity option, e.g., the conversion, being exercised. The conversion, as explained above, may be in the form of advanced payments, a lump sum distribution of a portion of the value of the annuity, or a lump sum death benefit.

Thus, where the demand is made for an advance of future payments, testing will entail determining whether the option was previously exercised and whether the current demand in combination with any previous demands fall within the maximum number of times the option may be exercised. For example, if the annuity limits the option to being used once, testing entails determining if the option has been previously exercised. Testing may further entail determining whether the amount of the demand falls within the maximum amount set forth in the annuity contract. If the maximum amount of the advance is five or six monthly future income payments, testing entails determining whether the demand is greater than five or six monthly future income payments, respectively. Additionally, if the option is limited to being exercised after the annuity payments begin for the demanding party, testing will entail determining whether the owner or beneficiary is entitled to receive income payments.

Where the demand is for a lump sum distribution of some or all of the value of the annuity, testing will similarly entail determining if the restrictions set forth in the annuity have been satisfied. Thus, testing may entail determining whether the option was previously exercised, the demand is timely, e.g., such as at about the fifth, tenth, and fifteenth anniversaries of a predefined date, such as income commencement date, or a defined window of opportunity based thereon, whether the demand is made in connection with a predefined event, such as those associated with catastrophic events including fire, flood, illness, etc., or whether the demand is within the maximum amount set forth in the annuity contract. In some embodiments, such predefined events may include the annuitant's reaching a predetermined age. Where the demand is for a lump sum death benefit, testing will entail determining whether the guarantee period for the annuitant has lapsed, e.g., the annuitant died, and whether there was any previous lump sum benefit distribution.

If at steps 202, 204, or 208 the demand fails with regard to the limitations or restrictions set forth in the annuity contract, the demand will be denied, step 208, and the above steps may be repeated for the next or subsequent demands. If the demand passes the testing criteria, the amount of liquid distribution may then be computed, step 210. Computing the liquid distribution will vary in accordance with the type of liquidity option for which the demand is being made. If the demand is for an advance of future income payments, the liquid distribution will be computed in accordance with the demand for the advance, such as the demand for a particular a dollar amount, an income period, e.g., six months of income (advance of five months of future income payments), or a plurality of future income payments, e.g., six monthly future income payments. In one embodiment, advances will not be discounted to reflect a loss based on the time value of money. Thus, an advance of six monthly future income payments of $300 will be $1,800. Alternatively, the advance will reflect the present value of the advanced future income payments at the time of the advance, thereby accounting for the loss based on the time value of money.

If the demand is for a lump sum distribution based on the commuted value of the annuity, the commuted value will be computed based at least partially on future income payments for the remainder of the guarantee period, such as for the term certain, e.g., 5, 10, 15, etc. years, or for the life expectancies of the annuitants and/or beneficiaries, or a portion thereof, such as 10%, 20%, 30%, etc. of the commuted value. In one embodiment, the amount of the demand for the lump sum distribution will be limited only to 30% of the commuted value, thus 30% of the commuted value will in this instance be computed. For a life annuity, the commuted value will therefore be based at least partially on the life expectancy of the annuitants. In one embodiment, the commuted value of a single life annuity, is computed with the following algorithm:

$${WD}_{g} = .3 \times {\sum }_{t = 1}^{max ( l - g , {e}_{x} - g )} {B}_{( g + t )} \times {v}_{wd ( g + t )}$$

where:
WD_{g}=commuted value at time g
g=number of months between income start date and withdrawal date
t=time measured in months since withdrawal date
Bₜ=monthly benefit at time t for an annuity starting with an initial benefit of $1.00

$$\begin{matrix}{e}_{x} = {\sum }_{t = 1}^{∞} {}_{t}^{}{p}{}_{x}^{} \\ = future life expectancy at issue for \\ person age x ( in months )\end{matrix}$$
x=issue age of primary annuitant (in months)
V_{wd(t)}=(1+i_{(g+t)}+0.01+IRCA)⁻⁽^{^{t}}^{/}^{₁₂₎} for (g+t)<361
V_{wd(t)}=(1+i₃₆₀+0.01+IRCA)⁻^{^{(360−g)}}^{/}^{₁₂} ×(1.055+IRCA)⁻^{^{(g+t−360)}}^{/}^{₁₂} for (g+t)>360
iₜ=interest rate applicable t months after issue
IRCA_{g}=1.00×(CMT_{(g)}−CMT₀) if CMT_{g}<CMT₀
IRCA_{g}=1.25×(CMT_{(g)}−CMT₀) if CMT_{g}>CMT₀
CMT_{g}=10 year Constant Maturity Treasury yield g months after issue
ₜpₓ=probability annuitant issued at age x survives t months after issue
   Similarly, the commuted value of a life annuity for joint life annuitants may be computed with the following algorithms:
If both annuitants are alive:

$${WD}_{g} = .3 \times {\sum }_{t = 1}^{max ( l - g , {e}_{xy ( bar )} - g )} {B}_{( g + t )} \times {v}_{wd ( g + t )}$$
If only annuitant x is alive:

$${WD}_{g} = .3 \times {\sum }_{t = 1}^{max ( l - g , {e}_{x} - g )} {B}_{( g + t )} \times {v}_{wd ( g + t )}$$
If only annuitant y is alive:

$${WD}_{g} = .3 \times {\sum }_{t = 1}^{max ( l - g , {e}_{y} - g )} {B}_{( g + t )} \times {v}_{wd ( g + t )}$$

where:
y=issue age of joint annuitant (in months)
ₜp_{y} probability annuitant issued at age y survives t months after issue

$$\begin{matrix}{e}_{y} = {\sum }_{t = 1}^{∞} {}_{t}^{}{p}{}_{y}^{} \\ = future life expectancy at isssue for \\ person age y ( in months )\end{matrix}$$

$$\begin{matrix}{e}_{xy} = {\sum }_{t = 1}^{∞} {}_{t}^{}{p}{}_{xy}^{} \\ = Joint status life expectancy at issue \\ ( fails upon first death ) ( in months )\end{matrix}$$

where:
ₜp_{xy}=ₜpₓ×ₜp_{y}
e_{xy(bar)}=Second to die status life expectancy at issue (fails on second death) (in months)
   If no primary annuitant specified: let e_{xy(bar)}=(k×eₓ)+(k×e_{y})+[(1−2k)×e_{xy}]If primary annuitant specified: let e_{xy(bar)}=eₓ+(k×e_{y})−(k×e_{xy})
   Where:
k=proportion of initial benefit that is paid upon 1st death. For example, if the benefit is scheduled to reduce from $100 to $70, then k=0.7.

In one embodiment, the commuted value for a single life annuity is computed with the following algorithms:
if g≧l (WD is after certain period)

$$X = {\sum }_{t = 1}^{360 - g} {B}_{( g + t )} \times {v}_{wd ( g + t )}^{t} \times {}_{( g + t )}^{}{p}{}_{x}^{}$$

$$Y = {\sum }_{t = 361 - g}^{∞} {B}_{( g + t )} \times {v}_{wd ( g + t )} \times {}_{( g + t )}^{}{p}{}_{x}^{}$$

$${WD}_{g} = .3 \times ( X + Y )$$
if g<l (within certain period)

$$X = {\sum }_{t = 1}^{l - g} {B}_{( g + t )} \times {v}_{wd ( g + t )}^{t}$$

$$Y = {\sum }_{t = l - g + 1}^{360 - ( l - g )} ( {B}_{( l - g + t )} \times {v}_{wd ( l - g + t )}^{t} \times {}_{( l - g + t )}^{}{p}{}_{x}^{} )$$

$$Z = {\sum }_{t = 361 - ( l - g )}^{∞} ( {B}_{( l - g + t )} \times {v}_{wd ( l - g + t )} \times {}_{( l - g + t )}^{}{p}{}_{x}^{} )$$

$${WD}_{g} = .3 \times ( X + Y + Z )$$
In one embodiment, the commuted value for a joint life annuity is computed with the following algorithms:
if the primary annuitant is selected:
   WD_{g}=0.3×[a+(k×b)−(k×c)]
if the primary annuitant is not selected:
   WD_{g}=0.3×[(k×a)+(k×b)+((1−2×k)×c)]
if g≧/(WD is after certain period)

$$a = ( {X}_{1} + {Y}_{1} ) , \\ where$$

$${X}_{1} = {\sum }_{t = 1}^{360 - g} {B}_{( g + t )} \times {v}_{wd ( g + t )}^{t} \times {}_{( g + t )}^{}{p}{}_{x}^{}$$

$${Y}_{1} = {\sum }_{t = 361 - g}^{∞} {B}_{( g + t )} \times {v}_{wd ( g + t )} \times {}_{( g + t )}^{}{p}{}_{x}^{}$$

$$b = ( {X}_{2} + {Y}_{2} ) , \\ where$$

$${X}_{2} = {\sum }_{t = 1}^{360 - g} {B}_{( g + t )} \times {v}_{wd ( g + t )}^{t} \times {}_{( g + t )}^{}{p}{}_{y}^{}$$

$${Y}_{2} = {\sum }_{t = 361 - g}^{∞} {B}_{( g + t )} \times {v}_{wd ( g + t )} \times {}_{( g + t )}^{}{p}{}_{y}^{}$$

$$c = ( {X}_{3} + {Y}_{3} ) , \\ where$$

$${X}_{3} = {\sum }_{t = 1}^{360 - g} {B}_{( g + t )} \times {v}_{wd ( g + t )}^{t} \times {}_{( g + t )}^{}{p}{}_{xy}^{}$$

$${Y}_{3} = {\sum }_{t = 361 - g}^{∞} {B}_{( g + t )} \times {v}_{wd ( g + t )} \times {}_{( g + t )}^{}{p}{}_{xy}^{}$$

The liquid distribution may then be made at step 212 in accordance with the annuity contract, e.g., the liquidity option elected. The distribution of the liquid asset may be made in a variety of ways as well, such as in the form of a cash value, which includes actual cash, payment by check, wire transfer, etc. The annuity information may then be updated, step 214, to reflect and/or account for the distribution. As noted above, where the distribution is in the form of an advance, subsequent future income payments may not be distributed for the time period for which the advance was taken. Thus, for example, an advance of six monthly future income payments may cause the future income payments to cease for the six months for which the advance was taken. Where the distribution is in the form of a lump sum distribution of the value of the annuity, subsequent future income payments may instead be reduced to reflect the distribution. Finally, where the distribution is a lump sum legacy benefit, the annuity information will be updated accordingly to reflect the distribution. The above steps may then be repeated for subsequent demands to convert at least a portion of the value of the annuity into a liquid asset.

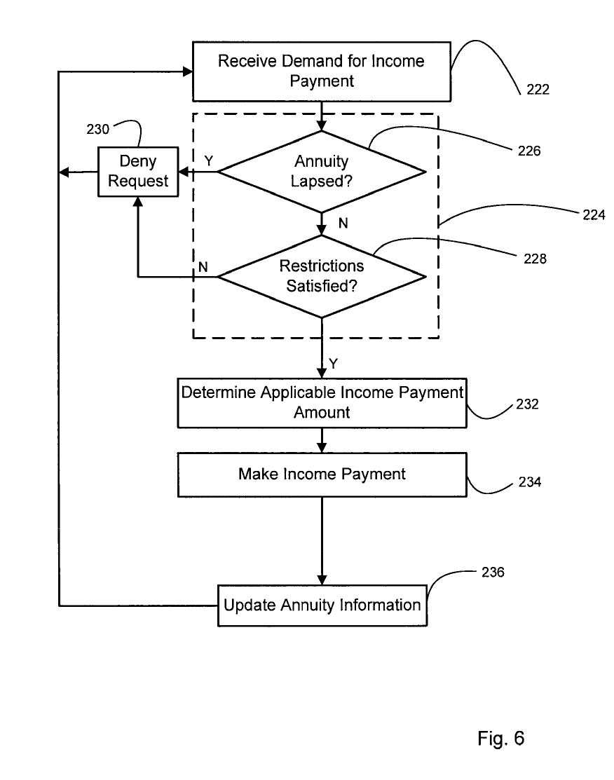

Referring to FIG. 6, a method of facilitating distribution of annuity payments in accordance with at least one flexible income rider begins, in one embodiment, at step 222 with receiving a demand for an income payment under an annuity contract. The demand may be received from the holder of the right under the annuity contract in a variety of ways, including a hard copy demand or an electronic version thereof. The demand may be automatically generated by the benefit provider, for example, an insurance company. For example, the demand may be automatically generated upon the insured reaching a specified age. In case of immediate annuities, the demand may be automatically generated on the first payment date specified by the annuity contract. The demand will then be tested at step 224 with the limitations set forth in the annuity for which the demand is received, and any corresponding information related thereto. Testing the demand at step 224 generally denotes determining whether or not the demanding party is eligible for the demanded payment.

In one embodiment, testing includes determining whether or not the annuity is still in effect or has otherwise lapsed at step 226. In another embodiment, testing includes determining whether or not any limitation or restriction that must be satisfied prior to any distribution is satisfied at step 228. Such restrictions may include, for example, eligibility restrictions specified in the annuity contract.

If at steps 224, 226, or 228 the demand fails with regard to the limitations or restrictions set forth in the annuity contract, the demand will be denied at step 230, and the above steps may be repeated for the next or subsequent demands. If the demand passes the testing criteria, the amount of income distribution will then be determined at step 232. Determining the amount of income distribution will generally include determining the applicable income level specified in the annuity contract with respect to the distribution date. The determined amount is paid to the demanding party at step 234 and the annuity information is updated at step 236.

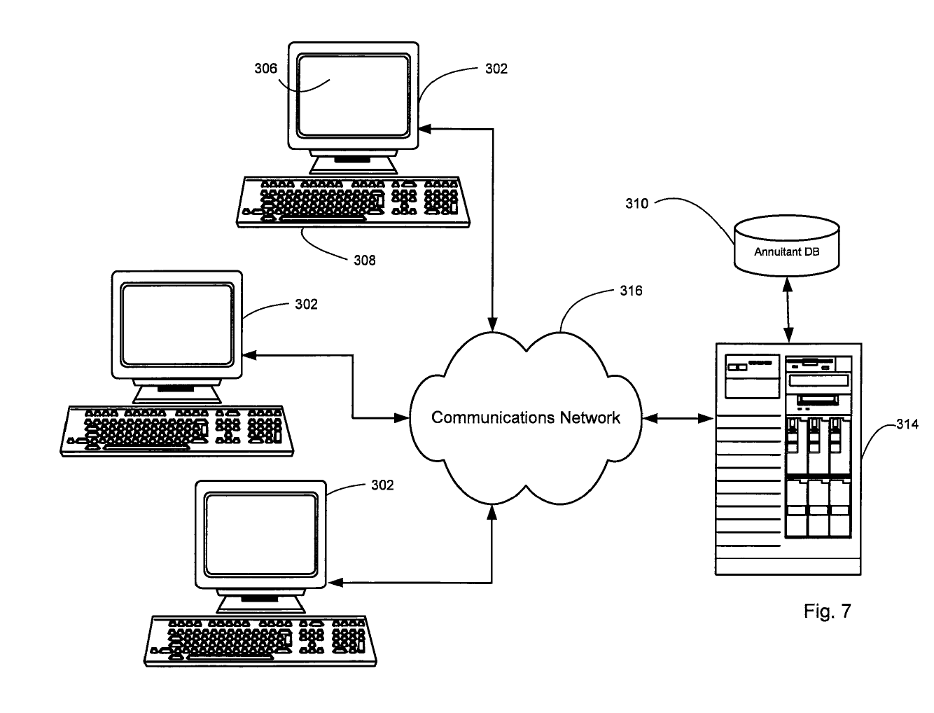

Referring to FIG. 7, a system useful in providing an annuity with several levels of income payments, including liquidity options, income level reset option based on interest rate changes, and/or flexible income riders according to one embodiment of this invention, includes a client interface 302 including a processor and associated computer memory, a display device 306, and an input device 308. This system can be used to implement all the methods and processes described herein either separately or in combinations. The client interface 302 is at least one of a programmable calculator, or a personal computer or special purpose computer including appropriate software or otherwise designed to compute or assist in computing first insurance premiums, subsequent insurance premiums, etc., according to the methods described herein. The software may be installed locally at the client interface 302, thereby enabling a user, such a broker, agent, or potential annuitant, to input information obtained regarding the annuity contract, and to compute or assist in computing a premium for the annuity given a selected or specified future income payments or future income payments given a selected or specified purchase price or premium. For annuities with at least one flexible income rider, an annuity variable may include one or more income change dates and corresponding income change percentages. In addition, the consumer may be able specify or select a particular product, for example, a deferred or immediate annuity and several desired levels of income and corresponding income change dates to the insurer. The software may be proprietary software designed to provide the methods described herein or, alternatively, commonly available software, such as spreadsheet or a database programs, adopted to perform the same.

In an alternative embodiment, the client interface 302 is communicatively connected to at least one server 314 over a communications network 316, such as a local area network (LAN), a wide area network (WAN), the Internet, the World Wide Web (WWW), a wireless network, or a combination thereof. The server 314 includes at least one database, such as an annuitant database 310. The annuitant database 310 generally includes information obtained that is useful for issuing and providing an annuity contract, such as personal information, annuity variables, annuity options, desired income levels and corresponding income change dates, and any other actuarial and statistical information suitable for issuing and providing an annuity contract.

In one embodiment, the client interface 302 accesses the relevant database or databases, stored locally at the client interface 302 or remotely at the server 314, for information necessary to compute or otherwise determining the premium or price of the annuity contract or the future income payments, and may update the relevant databases accordingly. Similarly, the client interface 302 accesses the annuitant database to compute the liquid distribution, e.g., the advance payment, the lump sum distribution, the applicable income distribution and corresponding income change date.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A computerized method of providing an annuity including a flexible income feature, the method comprising:
receiving information useful for issuing an annuity providing for a first level of income payments during a first time period and a second level of income payments different than the first payment level during a second time period following the first time period, the second payment level being contingent on at least one first event;
computing an annuity premium necessary to provide the first level of income payments and the contingent second level of income payments;
receiving at least a portion of the computed premium; and issuing the annuity.

2. The method of claim 1, wherein the annuity provides for the second level of income payments fixed in an amount certain contingent on an annuitant or beneficiary being alive on a fixed income change date.

3. The method of claim 1, wherein the annuity provides for the second level of income payments to be computed based at least in part on the first level of income payments and an interest rate increase fixed in an amount certain.

4. The method of claim 3, wherein computing the annuity premium comprises computing an option premium necessary to provide a difference between the first and second levels of income payments.

5. The method of claim 1, wherein the annuity provides for the second level of income payments to be in one or more variable amounts computed based at least in part on the first level of income payments and one or more interest rate increases.

6. The method of claim 1, wherein the annuity provides for the second level of income payments to be contingent on a change between the first and second time periods in a benchmark interest rate or index by a specified threshold amount.

7. The method of claim 6, wherein the benchmark interest rate or index comprises a constant maturity treasury index.

8. The method of claim 6, comprising a provider of the annuity funding the annuity by purchasing an option which may be exercised to pay in the event the benchmark interest rate or index changes by a second threshold amount.

9. The method of claim 1, wherein the annuity provides for income payment levels to continue to be at the first income payment level during the second time period if the first event does not occur.

10. The method of claim 1, wherein receiving the information comprises receiving the first income payment level and one or more criteria for computing the second income payment level.

11. The method of claim 10, wherein receiving the one or more criteria comprises receiving an interest rate and a date on which the second time period begins.

12. The method of claim 11, comprising computing the second payment levels as a function of the first payment levels and the interest rate.

13. A computerized method for funding a flexible income annuity, the annuity providing for a first level of income payments during a first time period and a second level of income payments different than the first payment level during a second time period following the first time period, the second payment level being contingent on a change between the first and second time periods in a benchmark interest rate or index by a specified threshold amount, the method comprising:
receiving an annuity premium from an annuitant;
computing a first portion of the received premium necessary to invest in a financial vehicle to fund the first level of income payments for at least the first time period; and
computing a second portion of the received premium to invest in an option that pays in the event the benchmark interest rate or index changes by the specified threshold amount on or about the beginning of the second time period.

14. A computerized method of providing an annuity including a flexible income feature, the method comprising:
receiving information useful for issuing an annuity, the information including a first level of income payments, a second level of income payments, and at least one income change date;
computing an annuity premium necessary to provide the first level of income payments before the occurrence of the income change date and the second level of income payments after the occurrence of the income change date;
receiving the computed premium; and
issuing an annuity providing for the first level of income payments before the occurrence of the income change date and the second level of income payments after the occurrence of the income change date.

15. The method of claim 14, wherein the annuity comprises a life annuity based on the life of at least one annuitant, guaranteeing future income payments for a duration of the life of the at least one annuitant.

16. The method of claim 14, wherein the received computed premium comprises a single payment.

17. The method of claim 14, wherein the annuity comprises an immediate annuity.

18. The method of claim 14, wherein the first and second level of income payments and the at least one income change date are selected at issuance the annuity.

19. The method of claim 14, wherein the first and second level of income payments and the at least one income change date remain the same for the life of the annuity.

20. The method of claim 14, wherein the income change date occurs on an anniversary of a commencement date to receive income payments.

21. The method of claim 14, wherein the second level of income payments is in the range of 1% to 400% more than or less than the first level of income payments.

22. The method of claim 14, wherein the flexible income feature is available to only those consumers of a certain minimum or maximum age.

23. The method of claim 14, wherein the second level of income payments may commence only after an annuitant attains a certain minimum or maximum age.

24. The method of claim 14, wherein the flexible income feature is not offered with other income payment modification options.

25. The method of claim 14, wherein the annuity comprises at least one liquidity option allowing the holder of the option to convert a portion of the value of the annuity into a liquid asset, the conversion comprising a lump sum distribution of at least a portion of a commuted value of the annuity computed based at least in part on the present value, at the time of the conversion, of future income payments for the remainder of the guarantee period.

26. The method of claim 25, wherein the annuity comprises a guarantee period based on the life of the annuitant and wherein the conversion comprises a lump sum distribution of at least a portion of the commuted value of the annuity computed based at least in part on the present value, at the time of the conversion, of future income payments for the life of the annuitant.

27-42. (canceled)
